(19) United States
(12) Patent Application Publication
(10) Pub. No.: US 2009/0075653 A1
(43) Pub. Date: Mar. 19, 2009

(54) Channel scanning method and apparatus for mobile node

(75) Inventor: Hae-Sung Yeom, Suwon-si (KR)

Correspondence Address: DOCKET CLERK, P.O. DRAWER 800889, DALLAS, TX, 75380, US

(73) Assignee: Samsung Electronics Co., Ltd., Suwon-si (KR)

(21) Appl. No.: 12/283,804

(22) Filed: Sep. 16, 2008

(30) Foreign Application Priority Data
Sep. 18, 2007 (KR) 2007-0094761

(51) Int. Cl. H04W 74/00

(52) U.S. Cl. 455/434

(57) ABSTRACT

A channel scanning method and apparatus for a wireless network is provided for improving channel scanning efficiency. A channel scanning method of the present invention includes selecting at least one of a plurality of available channels according to a predetermined channel selection formula; broadcasting a predetermined message on the at least one available channel; detecting response messages transmitted on the available channels in response to the predetermined message; and searching for access points on the basis of information extracted from the response messages.

### CROSS-REFERENCE TO RELATED APPLICATION(S) AND CLAIM OF PRIORITY

The present application claims priority to an application entitled “CHANNEL SCANNING METHOD AND APPARATUS FOR MOBILE NODE” filed in the Korean Intellectual Property Office on Sep. 18, 2007 and assigned Serial No. 2007-0094761, the contents of which are incorporated herein by reference.

### TECHNICAL FIELD OF THE INVENTION

The present invention relates to a wireless network and, in particular, to a channel scanning method and apparatus for a mobile node that is capable of improving channel scanning efficiency.

### BACKGROUND OF THE INVENTION

In a wireless network, particularly a wireless local area network (WLAN), an access point (AP) as a bridge between wireless and wired networks provides mobile nodes with Internet access and communication services.

In order for a mobile node to discover available APs, a mobile node scans frequency channels. There are two scanning techniques (i.e., active scanning and passive scanning), and the active scanning is preferably used. Also, there can be other network discovery techniques used for specific purpose (e.g., for finding hidden APs). In the case of the active scanning technique, the mobile node broadcasts a probe request message over available channels and receives probe response messages from the APs on the channels in response to the probe request message. The probe response message carries information basically required for connecting to the AP such as service set identifier (SSID) and channel number. Meanwhile, in the passive scanning technique, the mobile node receives beacons broadcasted by the APs and acquires information on the APs from the beacons. That is, the APs broadcast the beacons periodically for advertising their capabilities, and the mobile node selects one of the APs on the basis of the information acquired from the beacons. Since active scanning is superior to passive scanning in scanning time, the active scanning technique is dealt with hereinafter.

Typically, a frequency band given for a WLAN system is divided into 11 to 14 channels, and the availability of the channels are regulated by country. In many cases, multiple APs are deployed within a specific area. Accordingly, in order to find APs, the mobile node should broadcast the probe request message over all frequency channels available in the WLAN system. However, it is so time-consuming for the mobile node to transmit the probe request message and wait for receipt of the probe response messages over every channel.

Accordingly, there has been a need for an efficient channel scanning technique that is capable of reducing the channel scanning latency.

### SUMMARY OF THE INVENTION

To address the above-discussed deficiencies of the prior art, it is a primary object to provide a channel scanning method and apparatus for a wireless network that enables a mobile node to find available APs quickly.

Also, the present invention provides a channel scanning method and apparatus for a wireless network that is capable of reducing channel scanning latency by reducing a number of probe request transmission times.

In accordance with an exemplary embodiment of the present invention, a channel scanning method for a wireless network includes selecting at least one of a plurality of available channels according to a predetermined channel selection formula; broadcasting a predetermined message on the at least one available channel; detecting response messages transmitted on the available channels in response to the predetermined message; and searching for access points on the basis of information extracted from the response messages.

Preferably, the channel scanning method further includes transmitting the predetermined message on all of the available channels; receiving the response messages on all of the available channels; and re-searching for access points on the basis of information extracted from the response messages.

In accordance with another exemplary embodiment of the present invention, a channel scanning apparatus for a wireless network includes a control unit which selects at least one of a plurality of available channels in response to a detection of an access point discovery request and searches for access points on the basis of response messages received in response to a predetermined message transmitted on the at least one channel; and a radio communication unit which transmits the predetermined message on the at least one channel and receives the response messages on all of the available channels.

Preferably, the control unit includes a channel selector for selecting the at least one channel according to a predetermined channel selection formula; a message generator for generating the predetermined message; and a searcher for searching for the access points using the response messages.

Preferably, the control unit controls channel scanning again by broadcasting the predetermined message on all of the available channels, receiving the response messages on all of the available channels; and re-searching for access points on the basis of information extracted from the response messages.

Those skilled in the art will appreciate the scope of the present invention and realize additional aspects thereof after reading the following detailed description of the preferred embodiments in association with the accompanying drawings.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a conceptual diagram illustrating a communication network including well-deployed wireless local area networks according to an exemplary embodiment of the present invention;

FIG. 2 is a diagram illustrating a channel distribution of a frequency spectrum allocated to the communication network of FIG. 1;

FIG. 3 is a conceptual diagram illustrating overlaps between channels of a wireless network according to an exemplary embodiment of the present invention;

FIG. 4 is a block diagram illustrating a configuration of a mobile node according to an exemplary embodiment of the present invention; and

FIG. 5 is a flowchart illustrating a channel scanning method according to an exemplary embodiment of the present invention.

### DETAILED DESCRIPTION OF THE INVENTION

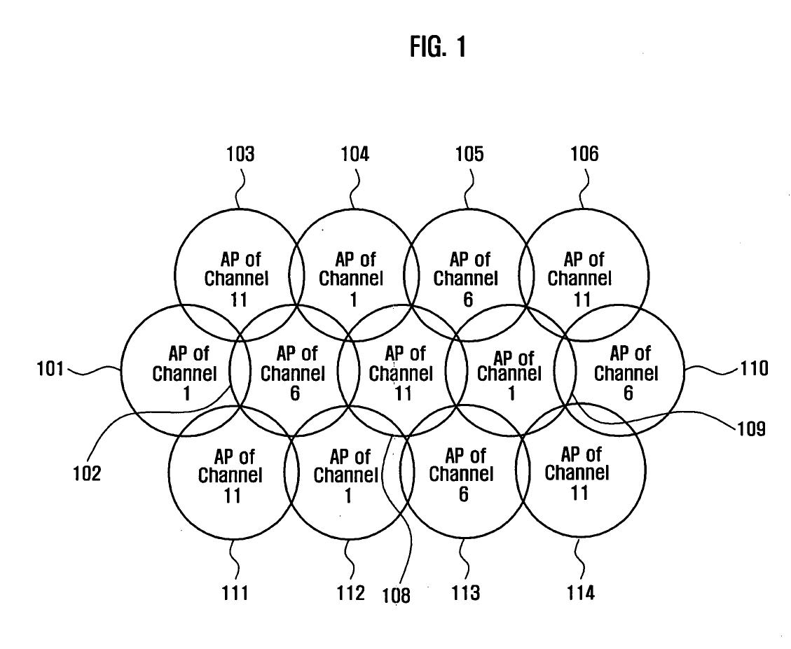

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

In the following, the selective channel scanning technique is described with a communication network in which a plurality of WLANs defined by radio coverage of respective APs are deployed so as to minimize interferences between them.

FIG. 1 is a conceptual diagram illustrating a communication network including well-deployed wireless local area networks according to an exemplary embodiment of the present invention.

If a plurality of APs are deployed within an area (e.g., a building) without consideration of neighbor APs frequency channels, the APs are likely to interfere each other. In order to improve network throughput, channel allocation should be done in consideration of interferences between neighbor APs. Referring to FIG. 1, the communication network includes sets of APs 101, 104, 109, and 112 using the channel 1; APs 102, 105, 110, and 113 using the channel 6, and APs 103, 106, 108, 111, and 114 using the channel 11. The APs are configured to use channels such that the channel of each AP differs from the channels of its neighbor APs, resulting in reduce interferences among neighbor APs.

Since the neighbor APs are configured to operate on different channels, a mobile node has to scan 3 different channels for find the APs. In order to find the available APs, the mobile node transmits a probe request message over a preferable channel. The probe request message is a frame transmitted for requesting information of neighbor nodes including APs. In a case that at least one AP exists on the channel through which the probe request message is transmitted, the AP transmits a probe response message to the mobile node in response to the probe request message such that the mobile node acquires information on the AP from the probe response message.

A WLAN, particularly Wireless Fidelity (WiFi), operates on the 2.4 Ghz frequency band that is divided into the multiple channels, such that the probe request message is transmitted over different channels. The number and availability of channels are regulated by country, constrained in part by how each country allocates radio spectrum to various services. Hereinafter, each frequency bandwidth constituting the given system frequency band is referred to as a “channel”. Also, in this embodiment, it is assumed that 11 channels are available and the communication network operates on the 2.4 GHz frequency band.

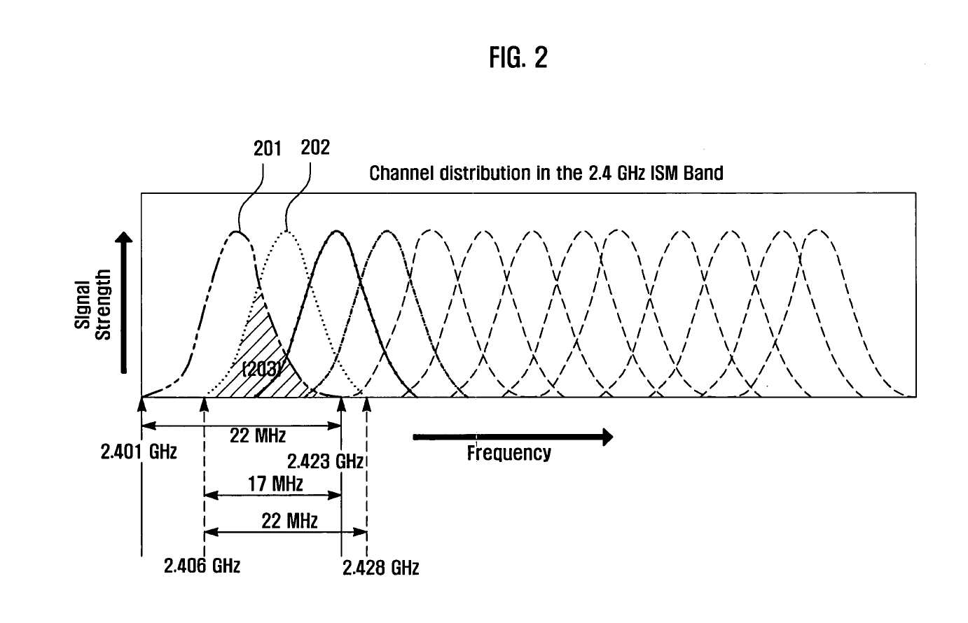

FIG. 2 is a diagram illustrating a channel distribution of a frequency spectrum allocated to the communication network of FIG. 1.

Referring to FIG. 2, the channel 1 (201) has a frequency bandwidth of 2.401 GHz ˜2.423 GHz, and channel 2 (202) has a frequency bandwidth of 2.406 GHz ˜2.428 GHz. In the same manner, channel 3 corresponds to the frequency bandwidth of 2.411 GHz ˜2.433 GHz, channel 4 corresponds to 2.416 GHz ˜2.438 GHz. Consequently, 13 channels are distributed in the 2.4 GHz band.

As shown in FIG. 2, each channel has a bandwidth of 22 MHz (e.g., the channel 1 (201) is 22 MHz wide (2.401 GHz ˜2.423 GHz), and the channel 2 (202) is also 22 MHz wide (2.406 GHz ˜2.428 GHz)). The channel 1 and channel 2 are arranged with an overlap 203 of 17 MHz and the overlap 203 is repeated between the channels.

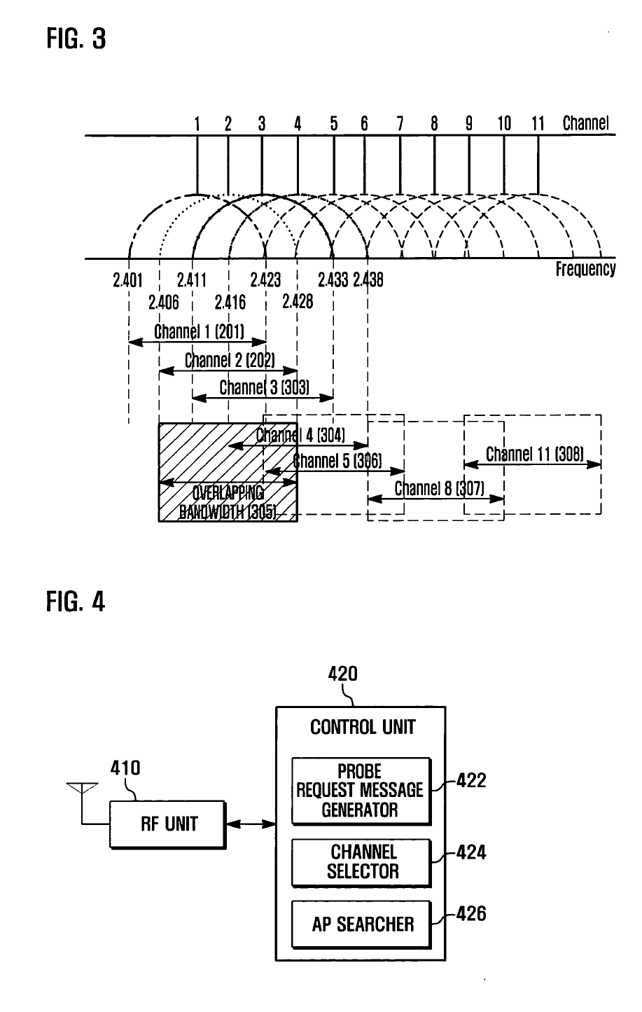

FIG. 3 is a conceptual diagram illustrating overlaps between channels of a wireless network according to an exemplary embodiment of the present invention.

As shown in FIG. 3, the bandwidths 2.401˜2.423 GHz of channel 1 (201), 2.406˜2.428 GHz of channel 2 (202), 2.411˜2.433 GHz of channel 3 (303), and 2.416˜2.438 GHz of channel 4 (304) overlap one another so as to create an overlapping bandwidth 305. Accordingly, an AP located at an area corresponding to the overlapping bandwidth 305 may receive the message transmitted on a channel allocated the other neighbor AP. For example, when an AP exists on the channel 3 and a mobile node broadcasts a message on the channel 2, the AP on the channel 3 overlapped with the channel 2 is likely to regard that the message is transmitted on the channel 3, thereby transmitting a response message to the mobile node through the channel 3. In this embodiment, a mobile node is allowed to receive a message transmitted on a neighbor channel.

Using such a channel overlapping characteristic, the mobile node broadcasts the probe request message on one of the overlapped channels rather than transmitting the message on the respective channels sequentially. For example, the mobile node broadcasts a probe request message on the channel 2 and waits for receiving probe response messages on the channels 1, 2, 3, and 4 that overlap one another in bandwidth. Since the probe request message is transmitted once through channel 2 which represents 4 channels by means of their overlap bandwidth 305, the channel scanning delay is reduced by at least ¼. Also, the APs on the 4 channels transmit the probe response messages during the same response period, thereby the entire round trip delay decreases significantly.

The channel on which the probe request message is broadcasted is determined by increasing the channel number by a natural number equal to or greater than 2. For example, the channel is selected according to one of formulas: 2m, 2m−1, 3n, 3n−1, 3n−2, 4k, 4k−1, 4k−2, and 4k−3 (m, n, k are natural numbers). In this embodiment, the channel selection is performed with the formula 3n−1 such that the channels 2, 5, 8, and 11 are selected as representative channels. Although the probe response messages received through an intended channel on which the probe request message is broadcasted are valid in the conventional channel scanning mechanism, the channel scanning method according to this embodiment allows the mobile node to accept the probe response messages received on the neighbor channels sharing the overlap bandwidth 305 as valid probe response messages. In order to clarify the tolerant range, it is assumed that only the neighbor channels are allowed to receive the probe response messages. For example, when the probe request message is broadcasted on channel 2, the probe response messages received on the neighbor channels 1 and 3 are accepted as valid probe response messages. Also, the channels 4 and 5 are allowed for channel 3. Of course, the range of valid neighbor channels can be expanded.

Similar to the channel 2 (202), the channels 5, 8, and 11 referred to as 306, 307, and 308, respectively, are overlapped with their neighbor channels. Accordingly, in this embodiment the channels 2, 5, 8, and 11 among 11 channels are used as the representative channels for broadcasting the probe request message.

FIG. 4 is a block diagram illustrating a configuration of a mobile node according to an exemplary embodiment of the present invention.

Referring to FIG. 4, the mobile node includes a radio frequency (RF) unit 410 and a control unit 420. The RF unit 410 is responsible for radio communication with a WLAN. The RF unit 410 includes a transmitter for up-converting and amplifying radio frequency signals to be transmitted and a receiver for low noise amplifying and down-converting received frequency signals. Although a single RF unit 410 is depicted in FIG. 4, the mobile node can be implemented with additional RF unit for supporting another communication system such as cellular communication system.

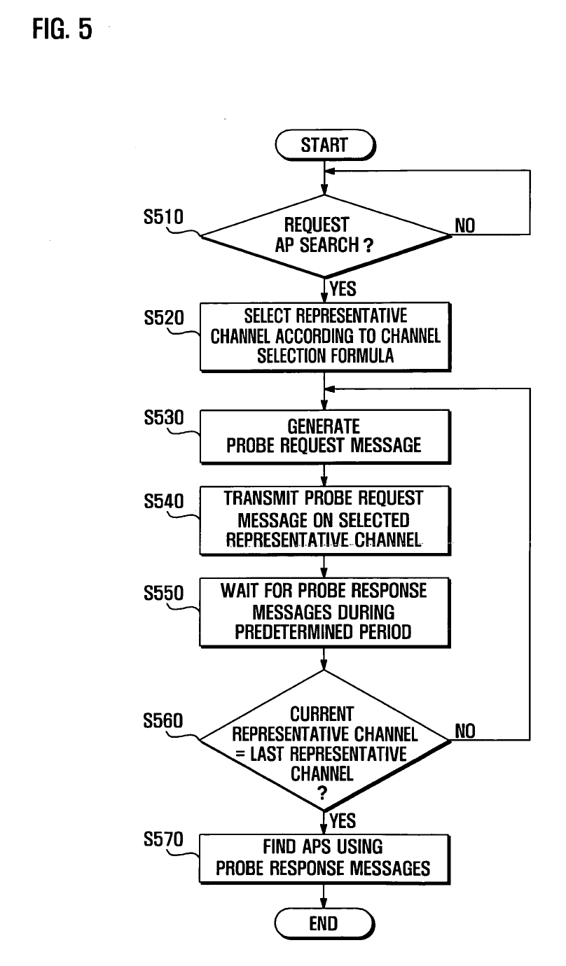

The control unit 420 controls general operations of the mobile node. Particularly in this embodiment, the control unit 420 controls the selection of a representative channel and the broadcast of a probe request message on the selected representative channel. For these purposes, the control unit 420 is provided with a probe request message generator 422, a channel selector 424, and an AP searcher 426. The operations of the probe request message generator 422, the channel selector 424, and the AP searcher 426 are described with reference to FIG. 5.

FIG. 5 is a flowchart illustrating a channel scanning method according to an exemplary embodiment of the present invention.

Referring to FIGS. 4 and 5, the control unit 420 of the mobile node first determines whether an AP search request is detected (S510). The AP search request is detected when the mobile node powers on or a WLAN interface is activated. When an AP scanning request is detected, the control unit 420, particularly the channel selector 424, selects a set of available channels (i.e., one of representative channel) according to a predetermined channel selection formula (S520). The representative channel selection is performed as described with FIG. 3. The representative channels are determined according to one of the formulas as mentioned above. In this embodiment, the representative channels are determined using the formula “3n−1” as an example. Accordingly, the representative channels are channels 2, 5, 8, and 11.

After selecting a representative channel, the control unit 420, particularly the probe request message generator 422, generates a probe request message (S530) and then broadcasts the probe request message on the selected representative channel (e.g., channel 2) (S540). After transmitting the probe request message on the channel 2, the control unit 420 waits for probe response messages during a predetermined period (S550) before broadcasting the probe request message on the next representative channel (i.e., channel 5). Preferably, the waiting time period is determined in the range of 10 ms to 30 ms. During the waiting period, at least one probe response message may be received. After the waiting time has expired, the control unit 420 determines whether the representative channel is the last representative channel (S560). If the representative channel is the last representative channel, the control unit 420 searches for available APs with reference to the information acquired from the probe response messages (S570). If the representative channel is not the last representative channel, the control unit 420 repeats step S530 such that the probe request message is broadcasted on all the representative channels 2, 5, 8 and 11.

At step S570, the control unit 420, particularly the AP searcher 426, searches for the APs existing on the channels on the basis of the information acquired from the probe response messages. The probe response message includes basic information for connecting to the AP, such as the SSID and the channel number of the AP. In this embodiment, the probe response messages received on the neighbor channels of the representative channel are valid such that the control unit 420 can find the APs existing on the channels 1 and 3 neighboring the representative channel 2, the channels 4 and 6 neighboring the representative channel 5, the channels 7 and 9 neighboring the representative channel 8, and channel 10 neighboring the representative channel 11. Unlike the conventional channel scanning method in which the probe request message is broadcasted on all of the 11 channels in a sequential order, the channel scanning method according to an embodiment of the present invention broadcast the probe request message on only 4 representative channels for scanning the 11 channels.

The channel scanning method according to this embodiment can scan all of the available channels by broadcasting the probe request message only on 4 representative channels unlike the conventional channel scanning method which broadcasts the probe request message over all of the 11 channels. Accordingly, the channel scanning method of the present invention can reduce the channel scanning latency without compromising channel scanning effect, resulting in fast AP discovery and in turn, reduction of roaming delay.

Although the channel scanning method is described in association with the WLAN hereinabove, the present invention is not limited thereto. For example, the channel scanning method of the present invention can be applied to various radio communication systems that allocate channels to access nodes overlappingly.

Although the channel scanning method is configured to scan channels one time by transmitting the probe request message on the representative channels selected by a predetermined channel selection formula, the channel scanning can be performed with other representative channel selected according to another channel selection formula or with entire channels for improving accuracy of the channel scanning results.

As described above, the channel scanning method of the present invention can obtain a full channel scanning effect by a transmitting probe request message on only a few representative channels, resulting in reduction of channel scanning latency. The reduced channel scanning time results in fast AP discovery and reduction of roaming latency.

Also, the channel scanning method of the present invention enables performing channel scanning procedure twice with different representative channel sets during the same period required for full channel scanning, thereby improving the accuracy of the channel scanning result.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A channel scanning method for a wireless network, comprising:
selecting at least one of a plurality of available channels according to a predetermined channel selection formula;
broadcasting a predetermined message on the at least one available channel;
detecting response messages transmitted on the plurality of available channels in response to the predetermined message; and
searching for access points on the basis of information extracted from the response messages.

2. The channel scanning method of claim 1, wherein the channel selection formula increases a channel number by i, where i is a natural number equal to or greater than 2.

3. The channel scanning method of claim 2, wherein the channel selection formula is one of 2m−1 and 2m, where m is a natural number.

4. The channel scanning method of claim 2, wherein the channel selection formula is one of 3n−2, 3n−1, and 3n, where n is a natural number.

5. The channel scanning method of claim 2, wherein the channel selection formula is one of 4k−3, 4k−2, 4k−1, and 4k, where k is natural number.

6. The channel scanning method of claim 2, wherein the channel selection formula can be switched to another channel selection formula.

7. The channel scanning method of claim 1, wherein the predetermined message is a probe request message, and the response message is a probe response message.

8. The channel scanning method of claim 7, wherein the probe response message contains information required to access the access point.

9. The channel scanning method of claim 1, further comprising:
transmitting the predetermined message on all of the plurality of available channels;
receiving response messages on all of the plurality of available channels; and
re-searching for access points on the basis of information extracted from the response messages.

10. A channel scanning apparatus for a wireless network, comprising:
a control unit which selects at least one of a plurality of available channels in response to a detection of an access point discovery request and searches for access points on the basis of response messages received in response to a predetermined message transmitted on the at least one channel; and
a radio communication unit which transmits the predetermined message on the at least one channel and receives the response messages on all of the plurality of available channels.

11. The channel scanning apparatus of claim 10, wherein the control unit comprises:
a channel selector for selecting the at least one channel according to a predetermined channel selection formula;
a message generator for generating the predetermined message; and
a searcher for searching for the access points using the response messages.

12. The channel scanning apparatus of claim 10, wherein the channel selection formula increases a channel number by i, where is a natural number equal to or greater than 2.

13. The channel scanning apparatus of claim 12, wherein the channel selection formula is one of 2m−1 and 2m, where m is a natural number.

14. The channel scanning apparatus of claim 12, wherein the channel selection formula is one of 3n−2, 3n−1, and 3n, where n is a natural number.

15. The channel scanning apparatus of claim 12, wherein the channel selection formula is one of 4k−3, 4k−2, 4k−1, and 4k, where k is a natural number.

16. The channel scanning apparatus of claim 12, wherein the channel selection formula can be switched to another channel selection formula.

17. The channel scanning apparatus of claim 10, wherein the predetermined message is a probe request message, and the response message is a probe response message.

18. The channel scanning apparatus of claim 17, wherein the probe response message contains information required to access the access point.

19. The channel scanning apparatus of claim 11, wherein the control unit repeats channel scanning by broadcasting the predetermined message on all of the plurality of available channels, receiving the response messages on all of the plurality of available channels; and re-searching for access points on the basis of information extracted from the response messages.
